(19) United States
(12) Patent Application Publication
(10) Pub. No.: US 2007/0272099 A1
(43) Pub. Date: Nov. 29, 2007

(54) Self-Inking Hand Stamp

(76) Inventor: Hartwig Pointl, Scharnstein (AT)

Correspondence Address: WILLIAM COLLARD;COLLARD & ROE, P.C., 1077 NORTHERN BOULEVARD, ROSLYN, NY, 11576, US

(21) Appl. No.: 10/592,001

(22) PCT Filed: Mar. 1, 2005
(86) PCT No.: PCT/AT05/00066

§ 371 Date: Sep. 7, 2006

(30) Foreign Application Priority Data
Mar. 8, 2004 (AT) A 396/2004

(51) Int. Cl. B41J 27/02

(52) U.S. Cl. 101/104

(57) ABSTRACT

A self-inking hand stamp (1) comprising a stamp housing (2) in which a stamp character(5)—carrying stamp unit (6) is arranged with a turning mechanism (7), which stamp unit is movable, by means of an actuating bow displaceably mounted on the stamp housing (2), from an inking position, in which the stamp characters abut on an ink pad (13) arranged within the stamp, into an imprint position. Within the actuating bow (3), a receiving compartment (17) for storing at least one further ink pad (18) is provided.

The invention relates to a self-inking hand stamp comprising a stamp housing in which a stamp character-carrying stamp unit is arranged with a turning mechanism by means of which the stamp characters are pivotably movable from an inking position in abutment on an ink pad that is exchangeably arranged in said stamp housing, into an imprint position oriented towards a surface to be imprinted, wherein, for actuation of the turning mechanism, an actuating bow is provided, which actuating bow is displaceably mounted on the stamp housing so as to overlap at least laterally said stamp housing and is coupled to said turning mechanism via lateral openings provided in said stamp housing, said actuating bow being urged into the position corresponding to the inking position by a spring arranged between the stamp housing and the actuating bow, and being manually movable against the force of this spring into the position corresponding to the imprinting position.

Self-inking hand stamps of the above-mentioned type (cf. e.g. WO 00/48843 A or U.S. Pat. No. 5,517,916 A) have an exchangeable ink pad which has to be refilled or renewed from time to time, as soon as its inking capacity has abated. In case of such a renewal, each time a new ink pad must be inserted the shape and dimensions of which must be appropriate for the respective stamp present. However, since different models and sizes of such stamps are on the market so that sometimes it may be difficult to rapidly obtain an ink pad which fits a certain stamp, the operational readiness of such stamps often may be negatively affected. Thus, when such a stamp is used only very rarely, an abating of the inking capacity often is not noticed, and then it may happen that the stamp, once it is needed, cannot provide acceptable imprints and a replacement pad cannot be sufficiently rapidly furnished.

It is an object of the present invention to provide a self-inking hand stamp of the initially defined type, which provides for the possibility of a rapid and easy insertion of a new ink pad when the inking capacity of its ink pad abates, without requiring particular efforts for furnishing the same.

The inventive self-inking hand stamp of the initially defined type is characterised in that a receiving compartment for keeping available at least one further ink pad is provided in the actuating bow. By this design, the object previously indicated can well be met, since it is also possible to keep available a further, unused ink pad within the stamp itself, which further ink pad can be used in a simple manner in case it is needed; sufficient time will then be available to furnish further ink pads, if desired, one of them again being housed as a replacement pad directly within the stamp, i.e. in the receiving compartment located in the actuating bow.

An embodiment of the self-inking hand stamp according to the invention which has a suitable construction and in which possibly the actuating bow, as it is present in common stamps of this type, requires only a moderate change of design, i.e. an enlargement of its structural height, is characterised in that the receiving compartment is located in that region of the actuating bow which, viewed in the direction of movement of the actuating bow, faces away from the spring. In this respect, an embodiment which is simple to construct and suitable for inserting and removing ink pads results if it is provided for the receiving compartment to be formed by a bottom wall provided at the actuating bow and by a cap covering this bottom wall at a distance therefrom. For the seating of the cap and also for operating the stamp it is suitable if on the actuating bow, on either side of the bottom wall, side walls adjoining the bottom wall are provided and the cap is arched and insertable between these side walls. The construction is further simplified if it is provided for the bottom wall of the receiving compartment, on its side facing away from the receiving compartment, to form a supporting rest for that end of the spring which engages on the actuating bow. In this manner, the bottom wall of the receiving compartment has a double function, i.e. the per se required support of the spring and the delimitation of the compartment provided to house a spare ink pad. The bottom wall may be designed to be closed over the entire interior of the actuating bow, or it may have openings or may be realized by one or several webs traversing the interior of the actuating bow.

In order to maintain a good ink delivery capacity of ink pads housed in the receiving space of the actuating bow, also over extended periods of time, in case these ink pads do not have a protective film envelope, as good a sealing as possible of this receiving space relative to the environment is advantageous. To this end, in the last-mentioned embodiment, e.g., it is possible to provide a continuous bottom wall and a tight fit of the cap.

A further embodiment of the self-inking hand stamp designed according to the invention which has a simple construction and in which also an ink pad present in the receiving compartment is very easily removable from this compartment is characterised in that the receiving compartment is formed by a wall opening provided in the actuating bow with insertion guides located therebehind, an ink pad being insertable in these insertion guides in drawer-like manner.

The invention will now be further explained with reference to a preferred exemplary embodiment illustrated in the drawing, without, however, being restricted to this embodiment. In the drawings,

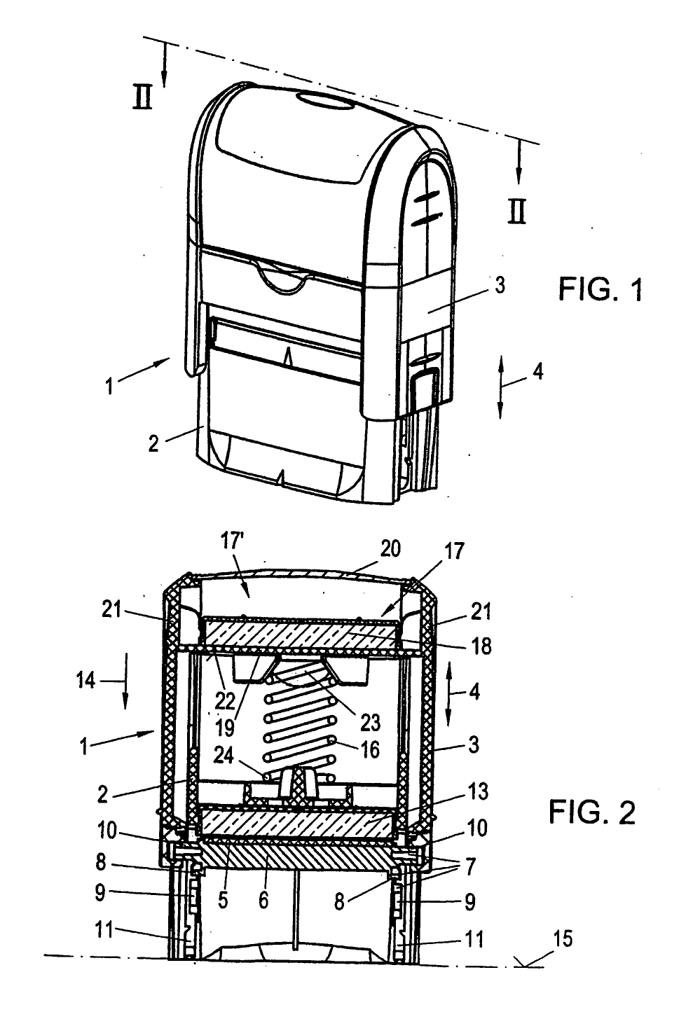

FIG. 1 shows an axonometric view of an example of a self-inking hand stamp designed according to the invention;

FIG. 2 shows this stamp in a section according to the middle plane, this middle plane extending according to line II-II of FIG. 1; and

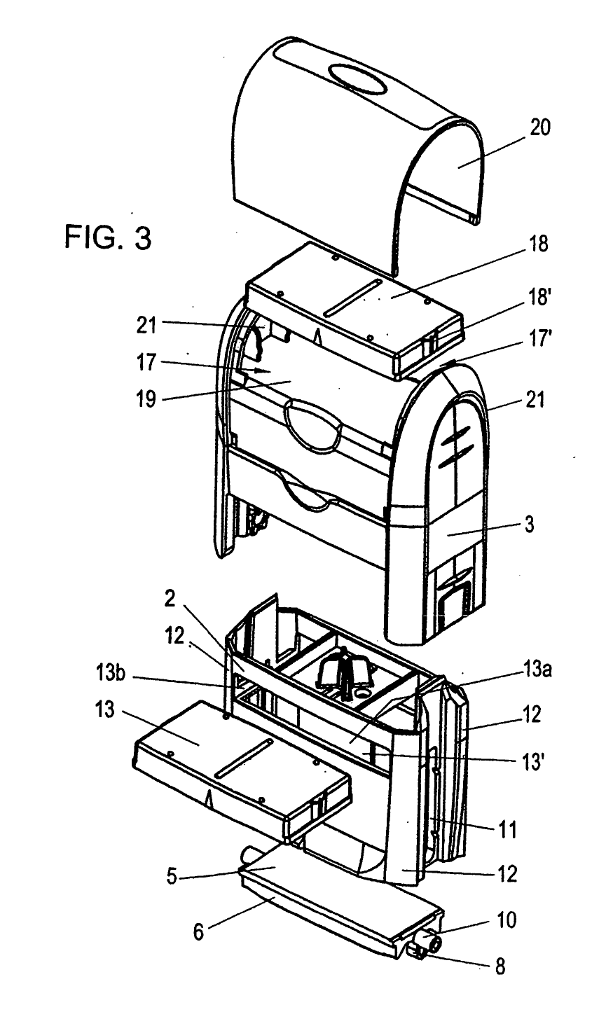

FIG. 3 shows an exploded illustration of this stamp, wherein the spring engaging on the actuating lever has been omitted for the sake of simplicity.

The exemplary embodiment of a self-inking hand stamp illustrated in the drawing has a stamp housing 2 on which an actuating bow 3 is mounted to be displaceable in the direction of the double arrow 4 (cf. FIGS. 1 and 2), laterally overlapping said housing 2. Within the stamp housing 2, a stamp unit is arranged which has a carrier plate (stamp unit) 6 carrying stamp characters 5 and a turning mechanism 7. The turning mechanism 7 is formed by turning pins 8 arranged on the carrier plate 6, turning grooves 9 arranged on the side walls 12 of the housing 2, and pivot pins 10, these pivot pins 10 being arranged on the carrier plate 6, projecting through lateral openings in the form of guiding slits 11 from the housing 2 and being coupled with the actuating bow 3.

In the position illustrated in FIGS. 1 and 2, the stamp characters 5 located on the carrier plate 6 assume the inking position in which they abut on an ink pad 13 exchangeably arranged in an insertion compartment 13′ in the stamp housing 2. In order to produce a stamp imprint on a surface 15 to be imprinted, the carrier plate 6 with the stamp characters 5 is brought into its imprint position by pressing the actuating bow 3 downwards in the direction of the arrow 14, in which latter position the stamp characters 5 come to abut on the surface 15 to be imprinted. By means of the turning mechanism 7, the carrier plate 6 with the stamp characters 5 thereon carries out a pivoting movement. The manually performed pressing down of the actuating bow 3 occurs against the force of a spring 16 arranged between the stamp housing 2 and the actuating bow 3, which spring is responsible for the stamp characters 5 to abut on the ink pad 13 when the stamp 1 is in its at-rest position. Via the pivot pins 10, the movement of the actuating bow 3 is transferred to the carrier plate 6 and the turning mechanism 7.

Within the actuating bow 3, in the upper transverse portion thereof, a receiving compartment 17 is provided in which at least one further ink pad 18 can be housed so as to be immediately available as a spare pad in case it is needed. This receiving compartment 17 is located in that region of the actuating bow 3 which, viewed in the direction of movement 4 of the actuating bow 3, faces away from the spring 16. Here, the receiving compartment 17 is formed by a bottom wall 19 provided at the actuating bow 3, and by a cap 20 covering said bottom wall 19 at a distance therefrom and closing an upper access opening 17′ of the receiving compartment 17. The bottom wall 19 may be continuous, as illustrated, or it may also have through-holes.

The actuating bow 3 has side walls 21 provided on either side of the bottom wall 19, adjoining the latter, and the cap 20 is arched and insertable between these side walls 21. On its side 22 facing away from the receiving compartment 17, the bottom wall 19 forms a supporting rest for that end 23 of the spring 16 which engages on the actuating bow 3. The other end 24 of the spring 16 is supported on the stamp housing 2.

By removing the cap 20, an ink pad 18 present in the receiving compartment 17 can be removed easily from the top side of said receiving compartment, in case this is needed, so as to be inserted in the stamp instead of the ink pad 13. The spare ink pad 18 can have lateral snap-in means 18′ in a per se conventional manner (cf. also the corresponding snap-in means not further designated on the ink pad 13), which cooperate with associated snap-in means on the walls 12 of the housing 2, or on the side walls 21 of the actuating bow 3, respectively, to secure the spare ink pad in its position.

If the cap 20 is transparent, also an information regarding the stamp imprint to be achieved by the stamp 1 can be arranged underneath this cap.

In a modified embodiment, the receiving compartment 17 in the upper region or transverse part of the actuating bow 3 may also be designed as an insertion compartment similar to the insertion compartment 13′ in the housing 2 for the ink pad 13 that is in operation, i.e. there are a forwardly located wall openings 13a and insertion guides 13b located therebehind into which the ink pad 18 can be inserted in drawer-type manner.

1: A self-inking hand stamp (1) comprising a stamp housing (2) in which a stamp character(5)—carrying stamp unit (6) is arranged with a turning mechanism (7) by means of which the stamp characters are pivotably movable from an inking position in abutment on an ink pad (13) that is exchangeably arranged in said stamp housing, into an imprint position oriented towards a surface (15) to be imprinted, wherein, for actuation of the turning mechanism (7), an actuating bow (3) is provided, which actuating bow is displaceably mounted on the stamp housing (2) so as to overlap at least laterally said stamp housing and is coupled to said turning mechanism via lateral openings provided in said stamp housing, said actuating bow being urged into the position corresponding to the inking position by a spring (16) arranged between the stamp housing (2) and the actuating bow (3), and being manually movable against the force of this spring into the position corresponding to the imprinting position, wherein a receiving compartment (17) for keeping available at least one further ink pad (18) is provided in the actuating bow (3).

2: A self-inking hand stamp according to claim 1, wherein the receiving compartment (17) is located in that region of the actuating bow (3) which, viewed in the direction (4) of movement of the actuating bow (3), faces away from the spring (16).

3: A self-inking hand stamp according to claim 2, wherein the receiving compartment (17) has an access opening (17′) towards the upper side of the actuating bow (3).

4: A self-inking hand stamp according to claim 2, wherein the receiving compartment (17) is formed by a bottom wall (19) provided at the actuating bow (3) and by a removably mounted cap (20) covering this bottom wall (19) at a distance therefrom.

5: A self-inking hand stamp according to claim 4, wherein at the actuating bow (3), on either side of the bottom wall (19), side walls (21) adjoining the bottom wall are provided and the cap (20) is arched and insertable between these side walls (21).

6: A self-inking hand stamp according to claim 4, wherein the bottom wall (19) of the receiving compartment (17), on its side facing away from the receiving compartment (17), forms a supporting rest for that end (23) of the spring (16) which engages on the actuating bow (3).

7: A self-inking hand stamp according to claim 1, wherein the receiving compartment (17) is formed by a wall opening provided in the actuating bow (3) with insertion guides located therebehind, an ink pad (18) being insertable in these insertion guides in drawer-like manner.
